(19) United States
(12) Patent Application Publication
(10) Pub. No.: US 2015/0200976 A1
(43) Pub. Date: Jul. 16, 2015

(54) WEB APPLICATION COLLABORATION SYSTEM, METHOD, AND COMPUTER-READABLE MEDIUM

(71) Applicant: Google Inc., Mountain View, CA (US)

(72) Inventors: Corey GOLDFEDER, Mountain View, CA (US); Nikhil SINGHAL, Mountain View, CA (US)

(21) Appl. No.: 13/779,579

(22) Filed: Feb. 27, 2013

(51) Int. Cl. H04L 29/06

(52) U.S. Cl. CPC H04L 65/403

(57) ABSTRACT

A system and method for browser-based collaboration is disclosed. A browser-based collaboration message-passing system can be established which mimics peer-to-peer browser communication. An exemplary system includes an application programming interface (API) that allows web application developers to cluster users of their applications into groups and a collaboration message server that transmits messages among clients and servers which are part of the same group. All collaboration application clients that belong to one group may interact with the same collaboration message server in order to send collaboration messages.

### BACKGROUND

Browser-based collaboration allows individual collaborators using separate browsers to communicate with one another and work together on things like shared documents and spreadsheets. However, creating real-time collaboration among web browsers can be challenging. Web security standards, including firewalls and network address translation for private address space make it difficult, if not impossible, for web browsers to directly connect with one another. Instead, web browsers are required to talk through servers. To transfer data, as illustrated in FIG. 1, one web browser running an application, Client A (103a), sends a message to its server, Server A (101a), which in turn sends a message to another server, Server B (101b), from which a second browser running the same application, Client B (103b), pulls the information. Browser technology requires that new information be pulled from a server as opposed to being pushed from the server to the browser when the information is available.

Web application developers need to have an easy way to pass messages among users' browsers for fast and efficient real-time collaboration. One way computer networks efficiently communicate is through peer-to-peer communication. In peer-to-peer networking, each computer in the network can act as a client or server for the other computers in the network. There should be a way to add functionality to existing web applications or hosted scripting environments that mimics peer-to-peer communications. This functionality should minimize server load and make multi-user collaboration scalable for multiple groups by increasing bandwidth and decreasing latency.

### SUMMARY

This specification describes technologies relating to browser communication in general, and specifically to methods and systems for browser-based collaboration that mimics peer-to-peer browser communication using a collaboration API and a collaboration server.

In general, one aspect of the subject matter described in this specification can be embodied in systems and methods for browser-based collaboration that mimics peer-to-peer communication. An exemplary system includes one or more processing devices and one or more storage devices storing instructions that, when executed by the one or more processing devices, cause the one or more processing devices to: aggregate collaborators running a web application into a group; assign the group to a collaboration message server; and route all group messages through the collaboration message server. A second exemplary system includes one or more processing devices and one or more storage devices storing instructions that, when executed by the one or more processing devices, cause the one or more processing devices to: create a group, join the newly created group, establish a connection to a collaboration message server associated with the group, and send collaboration messages via the collaboration message server. A third exemplary system includes one or more processing devices and one or more storage devices storing instructions that, when executed by the one or more processing devices, cause the one or more processing devices to: receive a request to establish a collaboration group for an application; establish the collaboration group; and responsive to receiving a request to send a group message, send the message to all collaborators in the group.

These and other embodiments can optionally include one or more of the following features: an iframe may be created in each collaborator's browser that serves all group requests and responses from each client to the collaboration message server; cross origin resource sharing may be used to serve all group requests and responses from each client to the collaboration message server; and an exemplary system or method may listen for a trigger in the application and, responsive to the trigger filing, send a message to all collaborators regarding the trigger.

The details of one or more embodiments of the invention are set forth in the accompanying drawings which are given by way of illustration only, and the description below. Other features, aspects, and advantages of the invention will become apparent from the description, the drawings, and the claims. Like reference numbers and designations in the various drawings indicate like elements.

### BRIEF DESCRIPTION OF THE DRAWINGS

FIG. 1 is a block diagram illustrating customary client/server interaction.

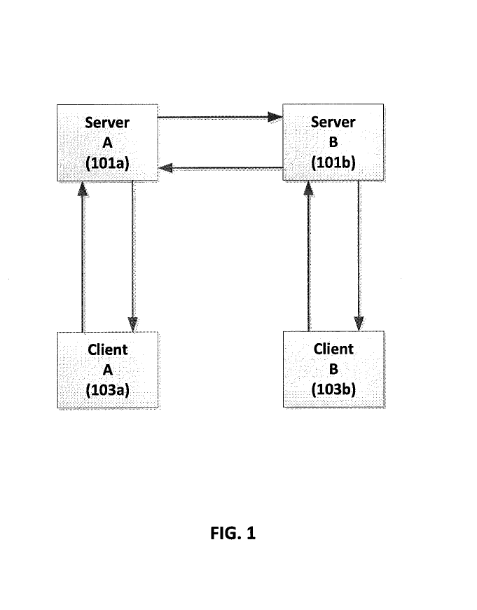

FIG. 2 is a block diagram illustrating exemplary client interaction with a collaboration message server.

FIG. 3 is a block diagram illustrating exemplary client and server interaction with a collaboration message server.

FIG. 4 is a block diagram illustrating exemplary client and server interaction with collaboration message servers.

FIG. 5 is a flow diagram of an exemplary method for browser-based collaboration message-passing.

FIG. 6 is a block diagram illustrating an exemplary computing device.

### DETAILED DESCRIPTION

According to an exemplary embodiment, a browser-based collaboration message-passing system can be established which mimics peer-to-peer browser communication. An exemplary system includes an application programming interface (API) that allows a web application developer to cluster collaborators running the developer's application into groups and a collaboration message server that transmits messages among clients and servers which are part of the same group. All collaborators who belong to the same group may interact with the same collaboration message server via their clients in order to send collaboration messages.

To create a group, a web application developer may use exemplary API to call a group creation method. For example, a web developer may write code similar to the following:

var group=script.collab.create(‘some group name’);

Using this code, a web developer can create a group named “some group name.” Collaborators running the developer's application can then join the newly-created group using the provided API. For example, a collaborator may run code similar to the following:

var joinedGroup=script. collab.join(‘some group name’);

This code will allow a collaborator to join the group named “some group name.” Once a collaborator joins a collaboration message group, the collaborator's web client receives a key that links the collaborator with the group and the group's associated collaboration message server. A key is created for every group to identify the group and associate the group with a collaboration message server. The key may be encrypted and may contain a group name and a scope. The scope may be used to avoid name collisions. For example, if Script A creates a group named “foo” and Script B creates a group named “foo” also, the “foo” groups are unrelated to each other and should be treated separately. In order for an exemplary system to distinguish the “foo” groups, each “foo” group's key may reference the scope for which the “foo” group is valid. Therefore, the key for Script A's “foo” group may be “script_a_foo” whereas the key for Script B's “foo” group may be “script_b_foo.”

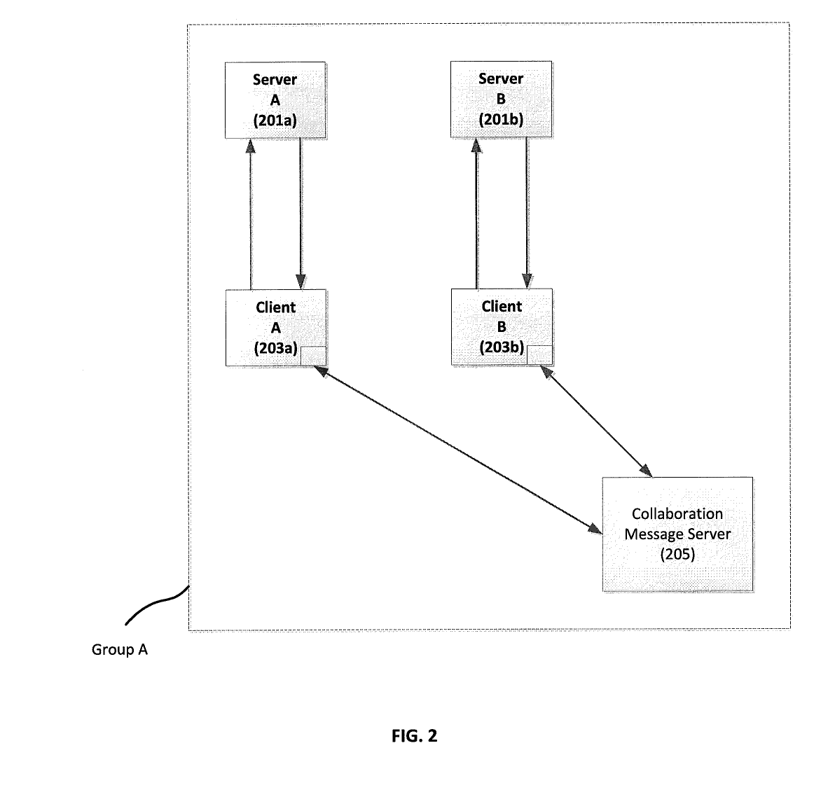

The collaborator's client collaboration messages as well as any collaboration messages sent from the server associated with the collaborator's client may be routed to the collaboration message server that corresponds to the group key. As illustrated in FIG. 2, collaborators from the same group are connected via the collaborators' client to one collaboration message server that serves all requests for that group.

A collaboration message server may use an HTTP request to communicate with collaborators via collaborators' clients. HTTP requests may include an action for creating cross-domain communication to allow a client to communicate with the collaboration message server. Cross-domain communication may be established in several ways. For example, an iframe may create a channel connection to the collaboration message server in each collaborator's client. Cross origin resource sharing (CORS) may also allow cross-domain communications. The channel connection may be created via a protocol that provides cross-browser compatible real-time, bi-directional communication In addition to establishing the channel connection from the client to the collaboration message server, the iframe may also contain an API for adding listeners to the channel.

Another http action used by the collaboration message server and collaborators to communicate may be a message action. This action may take a message and optionally a list of collaborators and send the message to the specified collaborators' channel connection.

Collaborators' client messages may be sent to all collaborators in a group. Alternatively, client messages may be targeted to only some collaborators. For example, code similar to the following may be used to send messages to all collaborators of a group:

group.sendMessage(‘some message’);

To send a message to specific collaborators, code similar to the following may be used:

group.sendMessageTo(‘some message’, [collaborator names]);

By specifying a list of collaborators' names, one collaborator can send messages to particular people and not just to the entire group. For example, a group may be created to play a game of bridge with friends. The list of collaborators may include all the names of people currently playing the game. One collaborator may want to reveal the cards in his hand to his wife. Code may then be written to find the collaborator's wife from the list of collaborators and send a message specifically to the collaborator's wife about the cards in his hand.

All collaboration messages may be sent through the collaboration message server (205) while maintaining the appearance of direct peer-to-peer messaging as shown in FIG. 2. Since all collaborators (203a, 203b) from one group may be locked onto the one collaboration message server, there is minimal need for server-to-server (201a, 201b) communication. Locking may occur using known server locking technology.

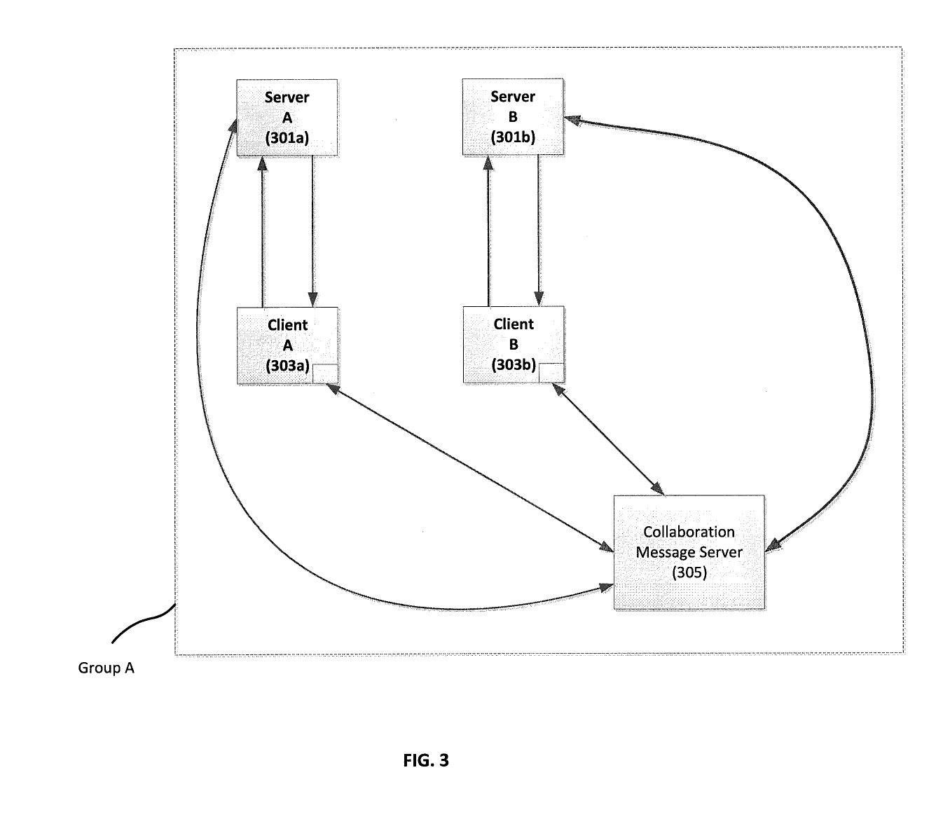

Servers may also send messages via a collaboration message server as shown in FIG. 3. A server may send messages to the group joined on the collaborator's client which is associated with the server. The server does not have to maintain its own communication channels to send messages.

Servers may communicate with a collaboration message server using remote procedure calls. There may be a remote procedure call for sending a message that is identical to the http action which sends a message. There may also be a remote procedure call for returning a list of collaborators given a group key.

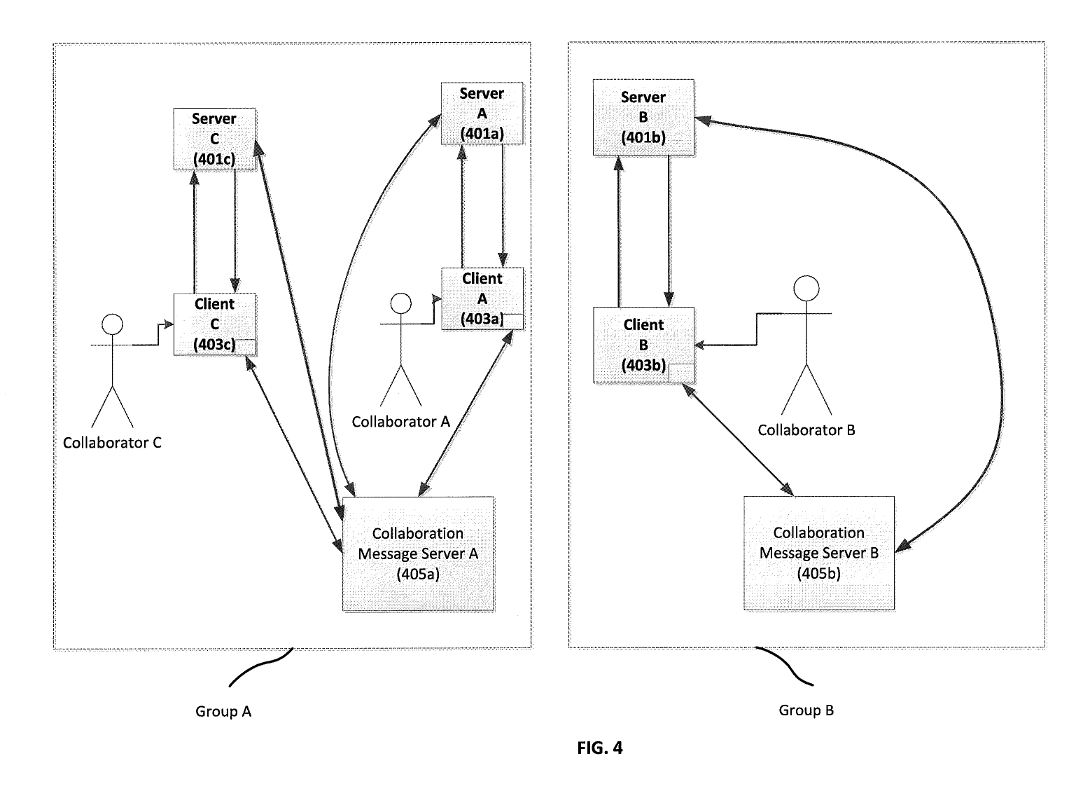

Although not a technical limitation, in an exemplary embodiment a policy decision may be made that a server may only send messages to the group joined on the server's associated client. For example, as illustrated in FIG. 4, Collaborator A's client is associated with a server that belongs to Group A whereas Collaborator B's client is associated with a server that belongs to Group B. Collaborator A's server (401a) may only send messages to the collaboration message server (405a) associated with Group A. Collaborator B, on the other hand, has messages routed through the collaboration message server (405b) which is associated with Group B. This policy decision may be implemented in order to encourage software developers to design their applications to facilitate sharing of collaboration servers. If a server relays messages to any group on any server, the advantage of collaborators sharing a collaboration server is lost.

In addition to being limited to sending messages to a collaboration server associated with the same group, a server may not join a group if no group has been joined on the client. This limitation is not technical, but it is a policy decision in order to prevent developers from circumventing the grouping mechanism. Actions to join or leave a group may happen only on the client. For example, if Client A (403a) was not associated with Group A, Server A(401a) could not communicate with Collaboration Message Server A (405a) or join Group A.

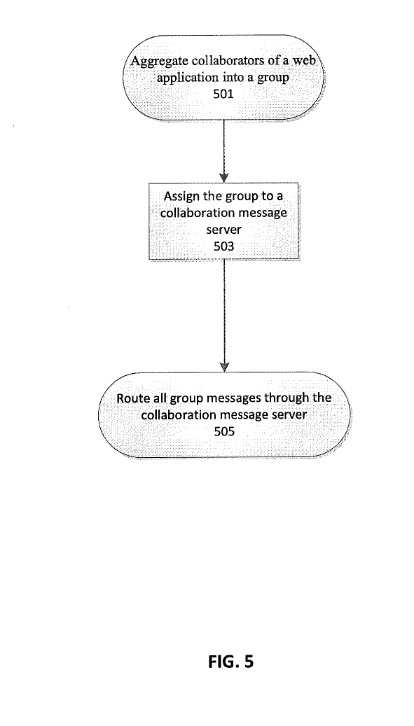

An exemplary method begins with aggregating users of a web application into a group as illustrated in FIG. 5 (501). The group should be assigned to a collaboration message server (503). Group communications from collaborators in a group are then routed through the same collaboration message server (505). Any group message from a group collaborator is sent via a channel connection established by an iframe in each collaborator's client.

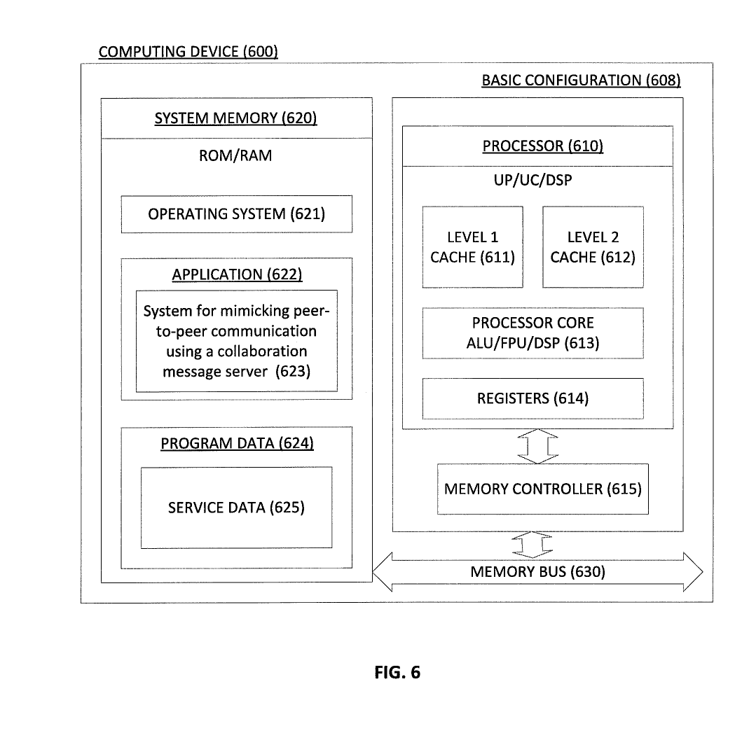

FIG. 6 is a high-level block diagram of an exemplary computer (600) that is arranged for browser-based collaboration and may be used to implement systems, apparatus, and methods described within this document. In a very basic configuration (601), the computing device (600) typically includes one or more processors (610) and system memory (620). A memory bus (630) can be used for communicating between the processor (610) and the system memory (620).

Depending on the desired configuration, the processor (610) can be of any type including but not limited to a microprocessor (μP), a microcontroller (μC), a digital signal processor (DSP), or any combination thereof. The processor (610) can include one more levels of caching, such as a level one cache (611) and a level two cache (612), a processor core (613), and registers (614). The processor core (613) can include an arithmetic logic unit (ALU), a floating point unit (FPU), a digital signal processing core (DSP Core), or any combination thereof A memory controller (616) can also be used with the processor (610), or in some implementations the memory controller (615) can be an internal part of the processor (610).

Depending on the desired configuration, the system memory (620) can be of any type including but not limited to volatile memory (such as RAM), non-volatile memory (such as ROM, flash memory, etc.) or any combination thereof. System memory (620) typically includes an operating system (621), one or more applications (622), and program data (624). The application (622) may include a method for browser-based collaboration. Program Data (624) includes storing instructions that, when executed by the one or more processing devices, implement a system and method for mimicking peer-to-peer communication using a collaboration message server. (623). In some embodiments, the application (622) can be arranged to operate with program data (624) on an operating system (621).

The computing device (600) can have additional features or functionality, and additional interfaces to facilitate communications between the basic configuration (601) and any required devices and interfaces.

System memory (620) is an example of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media can be part of the device (600).

The computing device (600) can be implemented as a portion of a small-form factor portable (or mobile) electronic device such as a cell phone, a tablet, a smartphone, a personal data assistant (PDA), a personal media player device, a wireless web-watch device, a personal headset device, an application-specific device, or a hybrid device that include any of the above functions. The computing device (600) can also be implemented as a personal computer including both laptop computer and non-laptop computer configurations.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers, as one or more programs running on one or more processors, as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of non-transitory signal bearing medium used to actually carry out the distribution. Examples of a non-transitory signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium. (e.g., a fiber optic cable, a waveguide, a wired communications link, a wireless communication link, etc.)

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

what is claimed is:

1. A system for browser-based collaboration that mimics peer-to-peer communication, the system comprising:
one or more processing devices and
one or more storage devices storing instructions that, when executed by the one or more processing devices, cause the one or more processing devices to:
aggregate collaborators running a web application into a group;
assign the group to a collaboration message server; and
route all group messages through the collaboration message server.

2. The system of claim 1 further comprising instructions to:
create an iframe in each collaborator's browser that serves all group requests and responses from each client to the collaboration message server.

3. The system of claim 1 further comprising instructions to:
use cross origin resource sharing to serve all group requests and responses from each client to the collaboration message server.

4. A system for browser-based collaboration that mimics peer-to-peer communication, the system comprising:
one or more processing devices and
one or more storage devices storing instructions that, when executed by the one or more processing devices, cause the one or more processing devices to:
create a group;
join the newly created group;
establish a connection to a collaboration message server associated with the group; and
send collaboration messages via the collaboration message server.

5. The system of claim 4 further comprising using an iframe to establish a connection to the collaboration message server associated with the group.

6. The system of claim 4 further comprising using cross origin resource sharing to establish a connection to the collaboration message server associated with the group.

7. A system for browser-based collaboration that mimics peer-to-peer communication, the system comprising:
one or more processing devices and
one or more storage devices storing instructions that, when executed by the one or more processing devices, cause the one or more processing devices to:
receive a request to establish a collaboration group for an application;
establish the collaboration group; and
responsive to receiving a request to send a group message, send the message to all collaborators in the group.

8. The system of claim 7 further comprising instruction to:
listen for a trigger in the application; and
responsive to a trigger firing, send a message to all collaborators regarding the trigger.

9. A computer-implemented method for browser-based collaboration that mimics peer-to-peer communication comprising:
creating a group;
joining the newly created group;
establishing a connection to a collaboration message server associated with the group; and
sending collaboration messages via the collaboration message server.

10. The computer-implemented method of claim 9 further comprising using an iframe to establish a connection to the collaboration message server associated with the group.

11. The computer-implemented method of claim 9 further comprising using cross origin resource sharing to establish a connection to the collaboration message server associated with the group.
